(19) United States
(12) Patent Application Publication
(10) Pub. No.: US 2008/0076427 A1
(43) Pub. Date: Mar. 27, 2008

(54) Apparatus, method, system, network element, and software product for discontinuous reception priority map to enhance measurement gap control

(75) Inventors: Leiping Huang, Saitama-ken (JP); Lars Dalsgaard, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/895,029

(22) Filed: Aug. 21, 2007

Related U.S. Application Data
(60) Provisional application No. 60/839,229, filed on Aug. 21, 2006.

(51) Int. Cl. H04Q 7/20

(52) U.S. Cl. 455/436; 455/450

(57) ABSTRACT

An apparatus, method, network element, system, and software product are provided for determining a target uplink or downlink transmission gap that would be advantageous during at least one measurement, such as a handover measurement. If the target transmission gap is greater than an allocated gap, then the invention combines at least one low priority period to form a consecutive gap that is at least as big as the target gap. The consecutive gap may include the allocated gap. Another innovation here is the notification of skipping gaps, from the user equipment to the network.

### CROSS-REFERENCE TO RELATED APPLICATION

The present application claims priority to U.S. Provisional Application 60/839,229 filed 21 Aug. 2006.

### BACKGROUND OF THE INVENTION

1. Technical Field

The present invention pertains to the field of telecommunications. More particularly, the present invention pertains to a long-term evolution (LTE) of wireless technology.

2. Discussion of Related Art

In the context of long-term evolution (LTE), there is a need to provide a tool for the network to create gaps in the transmission, if the current uplink (UL) and downlink (DL) data transmission and Discontinuous Reception (DRX) settings do not provide sufficient idle gaps. These idle gaps are useful to allow the UE to perform needed inter-frequency and inter-RAT (i.e. radio access technology) measurements, for example in a handover situation.

Those skilled in the art will be familiar with the Universal Mobile Telecommunications System (UMTS). Of interest here is an aspect of LTE called “evolved UMTS Terrestrial Radio Access Network,” also referred to as E-UTRAN. Of particular interest is how E-UTRAN active state Discontinuous Reception (DRX) functionality is related to measurement gap control for inter-RAT and/or inter-frequency operations (e.g. cell search for handover).

E-UTRAN—or 3.9 G/LTE—is a packet data transmission based system. This means that there is no dedicated circuit switched connection defined, unlike both second generation (2G) which has a dedicated mode, and third generation (3G) which has a cell dedicated channel state. A current working assumption in E-UTRAN is that all resources are assigned more or less temporarily by the network to the UE by use of allocation tables (AT), or more generally by use of a downlink (DL) resource assignment channel.

An active state DRX scheme is very critical in an LTE system in order to avoid the necessity of a user equipment (UE) continuously monitoring the allocation tables (AT). Such a scheme improves UE power consumption in an active state, for example. This is important because power saving is seen as a crucial element in LTE.

What is needed is a flexible DRX scheme that satisfies the following three diverse requirements. First, in order to ensure good power saving possibilities for UE, use as long a regular DRX period as possible, whenever possible. Second, in order to ensure good and fast throughput to and from the UE, use a regular DRX period that is as short as possible. Third, ensure timely handover measurement possibility for LEs.

LTE systems typically support three types of handover: intra-frequency handover, inter-frequency handover, and inter-RAT handover. Preferably, the UE needs to measure the channel of the target cell before handover execution, in order to identify the cell and improve switching time. A current working assumption is that the UE can execute LTE intra-frequency handover measurement in parallel with data reception, but dedicated data transmission gap periods of some pre-determined time may be needed for inter-frequency and inter-RAT measurement.

As mentioned above, there is a need to provide a tool for the network to create gaps in the transmission in situations when the current UL and DL data transmission and DRX settings do not provide sufficient idle gaps necessary for performing needed inter-frequency and inter-RAT measurements. Based on the needed gap patterns, the network needs to be able to signal the gaps to the UE. A current working assumption is that the gaps are needed only in situations where the currently used DRX (regular and/or interim) does not provide sufficient gaps for measurements. The network could know this based on the UE capabilities, based on information about scheduled DRX period, and/or based on UE measurement reports. One way to create such measurement gaps is by adjusting the regular DRX period via radio resource control (RRC) signaling. However, such methods cannot adapt a UE's DRX behavior quickly to the changing radio condition and to a user's changing measurement request.

The UMTS standard allows the transmission of data in two different states, namely a cell dedicated channel (CELL_DCH) state and a cell forward access channel (CELL_FACH) state. A compressed mode has been configured in UMTS to allow for inter-frequency/RAT measurements in CELL_DCH, whereas FACH measurement occasions have been configured for such measurements in CELL_FACH. These measurement gaps obey predefined patterns, and are provided irrespective of the instantaneous channel condition. Hence, according to the related art, a measurement gap can be given while the radio channel condition is good, thereby wasting the opportunity for efficient data transmission.

Applicant incorporates by reference herein, in its entirety, a document titled “3^{rd} Generation Partnership Project; Technical Specification Group Radio Access network; Physical layer aspects for evolved Universal Terrestrial Radio Access (UTRA) (Release 7),” 3GPP TR 25.814 V7.0.0 (2006-06). According to 3GPP TR 25.814, a current working assumption about measurement gaps is that, in case the UE needs UL/DL idle periods for making neighboring frequency measurements or inter-RAT measurements, the network needs to provide enough idle periods for the UE to perform the requested measurements. Such idle periods are created by the scheduler, i.e. it is assume that a compressed mode is not needed. In order to optimize the network, some additional measurements may be used by the network for triggering the generation of UL/DL periods. As of now, however, this matter has been left for further study (FFS).

### DISCLOSURE OF THE INVENTION

The present invention proposes a measurement gap control mechanism. This mechanism is based on priority in real time (RT) packets for long-term evolution (LTE) handover (HO) measurement and discontinuous reception (DRX) control.

RT applications typically contain both low and high priority parts of traffic. Also, a UE typically can finish measurement before the maximum allocated measurement period. Therefore, a new method is established based upon pre-defined priority of DL traffic.

Typical real time applications such as VoIP and video streaming have a fixed and short arrival interval. This will result in a short interval regular DRX period, which conflicts with UE's requirement for a long measurement gap (i.e. the target gap is greater than the allocated gap). On the other hand, many RT applications support a certain level of packet loss without seriously disturbing the user's perceived Quality of Service (QoS).

For example, an MPEG-2 video bitstream is made up of a series of data frames encoding pictures. The three ways of encoding a picture are: intra-coding (I pictures), forward prediction (P pictures), and bidirectional prediction (B pictures). A sequence of different frame types, beginning with an I picture and ending just before the subsequent I picture, is called a Group of Pictures (GOP). The application may choose the length and frame types present in a GOP, but commonly, a GOP is 15 frames long, and has the sequence I_BB_P_BB_P_BB_P_BB_P_BB_. Loss of part of P and B pictures will not seriously disturb the users' perceived QoS. Similar priority-based coding schemes can be found in other applications such as Voice over IP with adaptive multi-rate speech codec (AMR) coding.

On the other hand, a user equipment (UE) is allocated with a period of time as a measurement gap. In practice, this period is a conservative estimation of the necessary period for inter-RAT inter-system measurement. So, the UE may finish its measurement activity before the maximum allocated time.

As mentioned, the present invention is based on pre-defined priority of DL traffic. The UE is notified, during the initialization of regular DRX period phases, of the priority of the DL traffic between different regular DRX periods. When there is a need to allocate a long gap for measurement (i.e. when it is determined that a target gap would be advantageous), the UE combines several low priority DRX periods to form a consecutive gap for measurement. The UE skips all DL traffic within this measurement gap.

Also, at the Node B side, a packet scheduler should discard those low priority packets, instead of retransmission when Hybrid Automatic-Repeat-Request (HARQ) reports transmission error. This avoids extra retransmission on radio channel.

A noteworthy benefit of this invention is that the UE avoids additional RRC signaling to adjust the DRX periodicity. Also, when the UE finishes the measurement before a maximum allocated gap, it can continue packet reception without additional signaling to resume the traffic.

### BRIEF DESCRIPTION OF THE DRAWINGS

FIG. 1 is a flow chart showing a method for creating consecutive measurement gaps, according to an embodiment of the present invention.

FIG. 2 is an illustration of an MPEG2 system according to an embodiment of the present invention.

FIG. 3 is a flow chart showing a method according to a further embodiment of the present invention.

FIG. 4 is a block diagram illustrating a mobile terminal according to an embodiment of the present invention.

FIG. 5 illustrates a system according to an embodiment of the present invention.

### DETAILED DESCRIPTION OF THE INVENTION

An embodiment of the present invention will now be detailed with the aid of the accompanying figures. It is to be understood that this embodiment is merely an illustration of one particular implementation of the invention, without in any way foreclosing other embodiments and implementations.

According to one of the preferred embodiments of the invention, an MPEG2 streaming application can be used. Each Group of Pictures (GOP) is composed of 15 frames, and occupies 600 milliseconds. The packet interval between two frames is equal to 40 ms. Without the present invention, the UE needs to wake up every 40 ms for packet reception to avoid buffering in an evolved Node B (eNB). Excluding the time for data reception, the time left (e.g. 30˜35 ms) is not always long enough for a normal inter-RAT/inter-frequency HO measurement. For example, in LTE it is expected that 20 ms is enough for cell identification. But for 2G, approximately 50-60 ms would be needed.

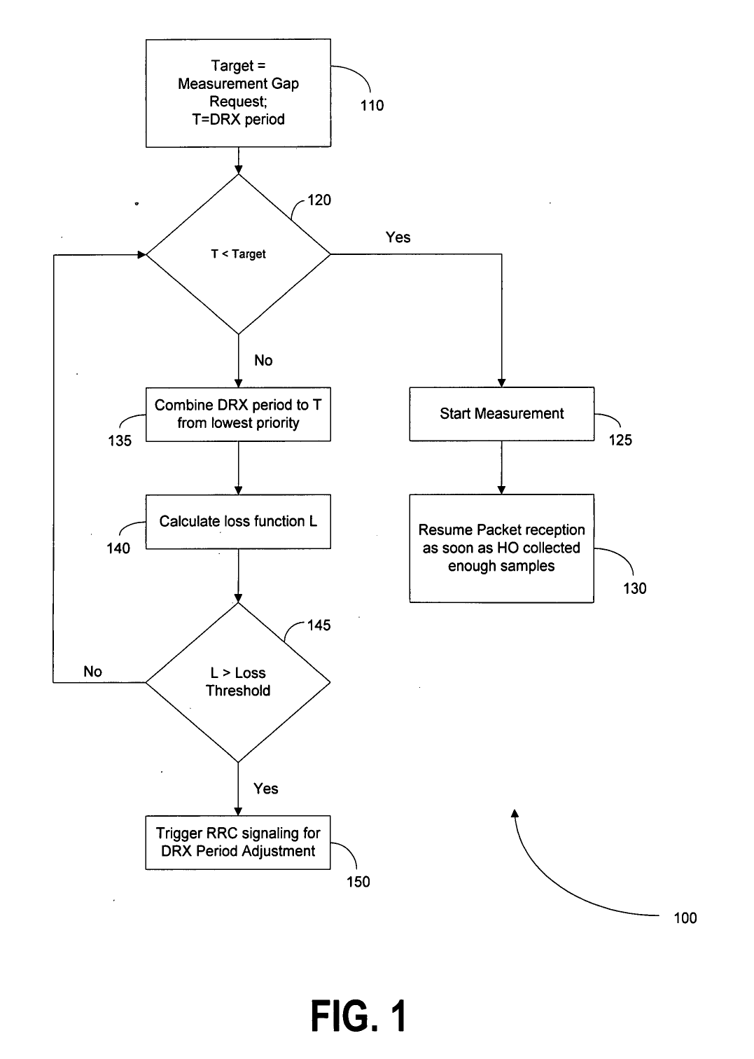

According to this embodiment of the invention, the node B (NB) sends a priority map, with loss threshold, before the start of the session, as part of a DRX setup message. FIG. 1 is a flowchart of a method 100 according to this embodiment of the invention. When the UE needs 110 a measurement gap, it will first check 120 whether the existing DRX periodicity (T) can satisfy the desired gap (Target). If the current DRX period is adequate, then the measurement starts 125 and then the gap ends 130. However, if the current DRX period is too short, the UE checks the priority map of different DRX periods. The UE was notified of the priority order as I>P>B; for example, here is a table showing an example of a priority map of an MPEG2 stream:

| DRX Period ID | 0 | 1 | 2 | 3 | 4 | 5 | 6 | 7 | 8 | 9 | 10 | 11 | 12 | 13 | 14 |
|---|---|---|---|---|---|---|---|---|---|---|---|---|---|---|---|
| Priority | 1 | 3 | 3 | 2 | 3 | 3 | 2 | 3 | 3 | 2 | 3 | 3 | 2 | 3 | 3 |
| Loss Value | 5 | 1 | 1 | 2 | 1 | 1 | 2 | 1 | 1 | 2 | 1 | 1 | 2 | 1 | 1 |

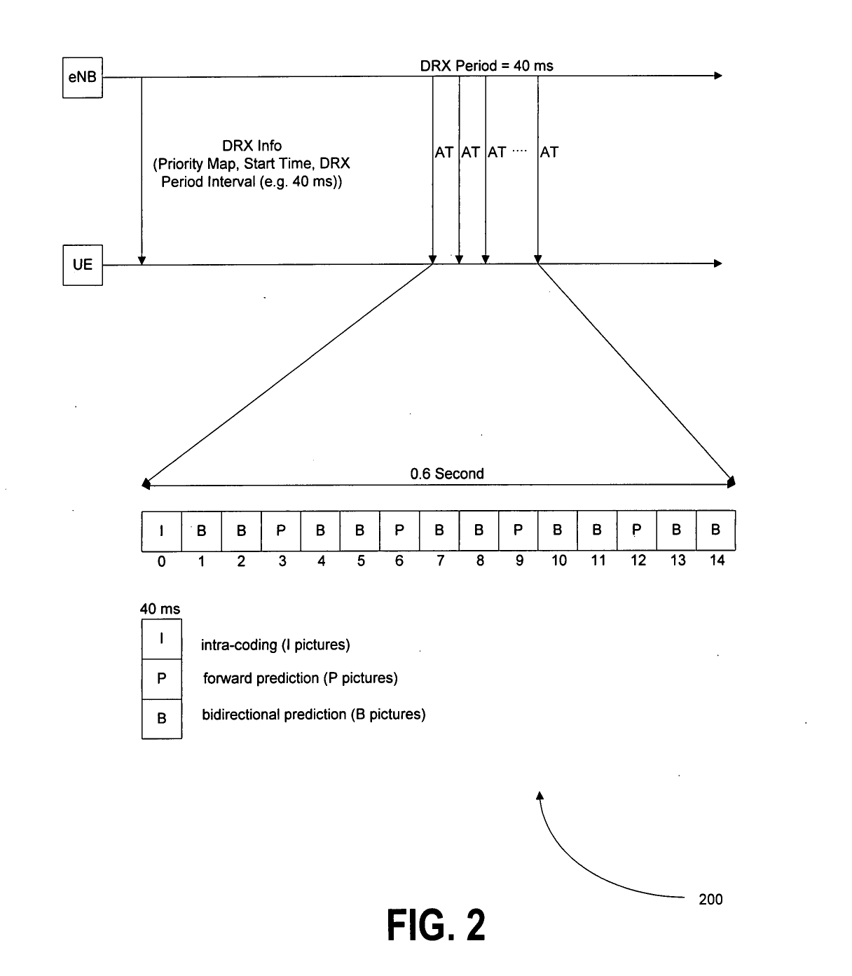

The periods 1-14 are shown in the MPEG system 200 of FIG. 2. The B pictures have the following DRX period identifications: 1, 2, 4, 5, 7, 8, 10, 11, 13, and 14. The corresponding priority for each of those periods is three (3), as indicated in the table. In contrast, the priority for each of the P pictures is two (2), and the priority for each of the I pictures is one (1), so that the priorities satisfy the relation I>P>B.

After checking the priority map, the UE will start combining 135 the lowest priority DRX periods to create a consecutive period for the measurement gap. A loss function is also used here, as shown in the table above. The loss value in the priority map is counted 140 when the UE chooses a measurement gap. If the combined gap is larger than the loss threshold 145, then the priority map algorithm has failed, which triggers 150 RRC signalling for DRX period adjustment. However, if the combined gap is less than the loss threshold, then the method iterates back to checking 120 whether the combined gap can satisfy the desired gap (Target).

The creation of a priority map is fully controlled by the eNB. The detailed algorithm of priority map creation will be apparent to a person skilled in the art. Inputs such as application type, application QoS profile, and packet scheduling policy can, of course, be taken into account during the priority map creation. The network—when it notices through the measurement report that the UE needs measurement gaps—can send in DL the DRX skip indicator map to the UE, or alternatively the map can be specifically requested by the UE.

Another issue here is the notification of skipping gaps, from the UE to the eNB. Several uplink feedback channels such as Channel Quality Indicator (CQI) report, measurement report, and/or buffer status report can be used for this notification purpose. The UE notifies the eNB (before the skipping) that it will skip several DRX periods. Then, the eNB can discard those packets without wasting any DL resources. A HARQ process can be also improved when eNB transmits those low priority packets. For example, the eNB will not trigger outer-ARQ (RLC) for low priority packets, but instead will discard them directly. However, in non-acknowledgement mode, the UE can skip those DRX periods without notification, although this will waste the DL resources, and increase interference on the cell. In this disclosure, neither of these choices is excluded: sending and not sending notification signal about DRX skipping. This may become a trade-off factor in the planning of a real LTE RAN, but the point is that notification of skipping can be useful in non-acknowledgment mode.

Thus, two embodiments are presented here for notifying the constructed map from the UE to eNB. The first is for non-acknowledgement mode, and the second is for acknowledgment mode.

In non-acknowledgment mode, the method is to skip reception of packets directly before and after the consecutive measurement gap; UE constructs the consecutive measurement gap by itself based on priority map notified from the eNB. The UE directly skips the reception of those packets without any extra signaling. After the end of the measurement, the UE directly restarts reception of those low priority packets. Within this period of time, the eNB still transmits those DL low priority packets, but UE cannot receive them. This wastes DL radio resources. On the other hand, UE does not need to explicitly inform the “skip” and “end of skip,” which saves UL resources. One extension of this approach is the change of HARQ behavior in eNB for those low priority packets, because they may be discarded directly by UE. eNB does not trigger out-ARQ process for low priority packets because UE may skip those packets.

In acknowledgement mode, the method is to signal from UE to eNB before and after skipped packets (consecutive measurement gap); the UE constructs the consecutive measurement gap by itself based on priority map. UE first notify this gap to eNB before the gap. Within this gap, UE is doing some handover (HO) related measurement. After that, UE needs to notify the end of skip, if UE can finish measurement before allocated consecutive measurement gap. This avoids eNB to transmit low priority packets when UE is doing measurement, but requires extra signaling before and after the gap.

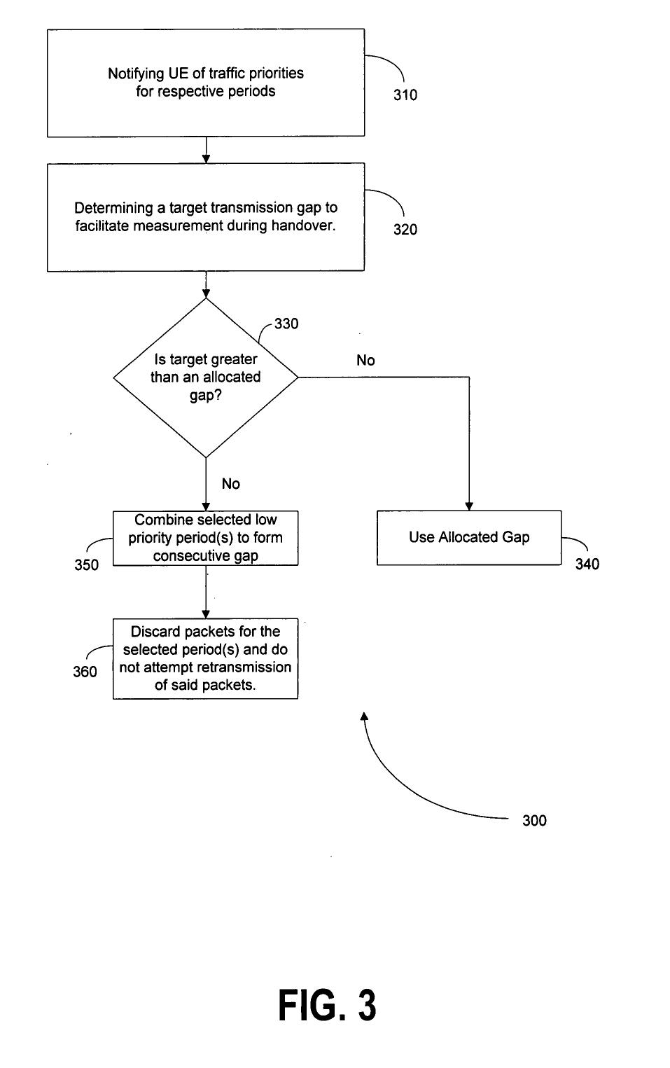

Turning now to FIG. 3, a further method 300 is shown according to the present invention. The network initially notifies 310 the UE of traffic priorities for respective periods, and this notification can be in the form of a map that maps the priorities to the periods. Then the UE determines 320 a target transmission gap that would facilitate measurement during handover. Subsequently, the target gap is compared 330 to a gap that was already allocated by the network. If the target gap is less than or equal to the allocated gap, then the allocated gap is used 340. However, if the target gap is greater than the allocated gap, then one or more selected low-priority periods are combined 350 to form a consecutive gap. Then, packets are discarded 360 for the selected period(s) so that there will be no retransmission attempt.

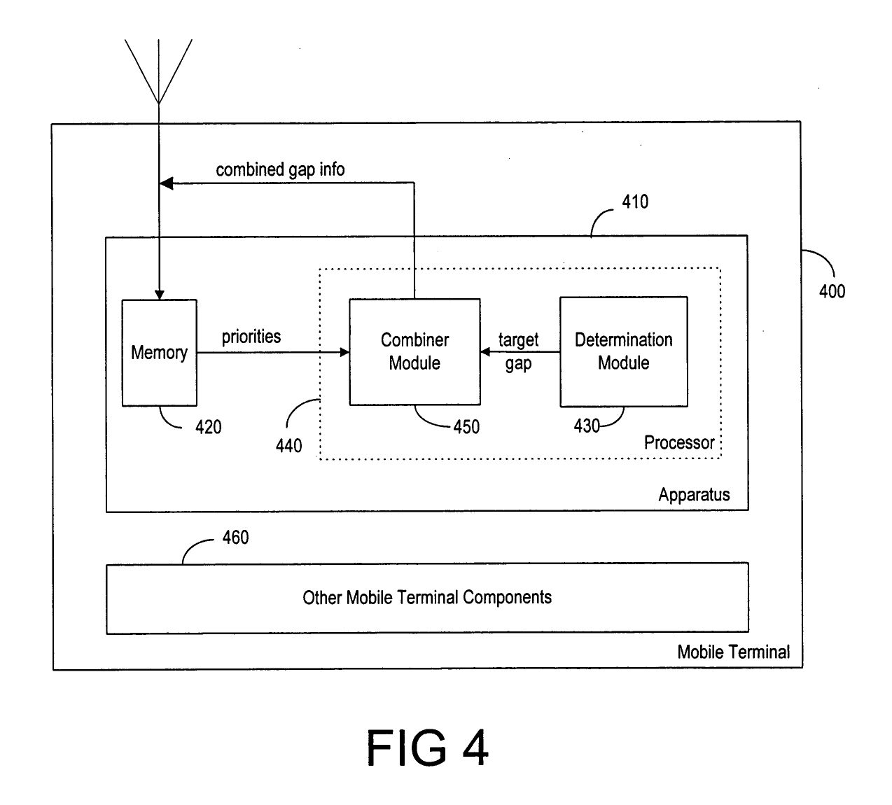

FIG. 4 shows how a mobile terminal 400 according to an embodiment of this invention. An apparatus 410 within the terminal is used for the purpose, whereas other components 460 are not directly relevant. Within the apparatus 410, a memory 420 receives a mapping of the priorities via an antenna. A processor 440 includes a combiner module 450 which uses the mapping of priorities when handover measurements are imminent. A determination module 430 within the processor determines if any combining will be necessary, and if so a target gap is provided to the combiner module. The combiner module will then combine at least one low-priority period, in order to form a consecutive gap, and information about this combined gap is then provided to the network via the antenna. In that way, the network will be able to prevent transmission and retransmission during the combined consecutive gap.

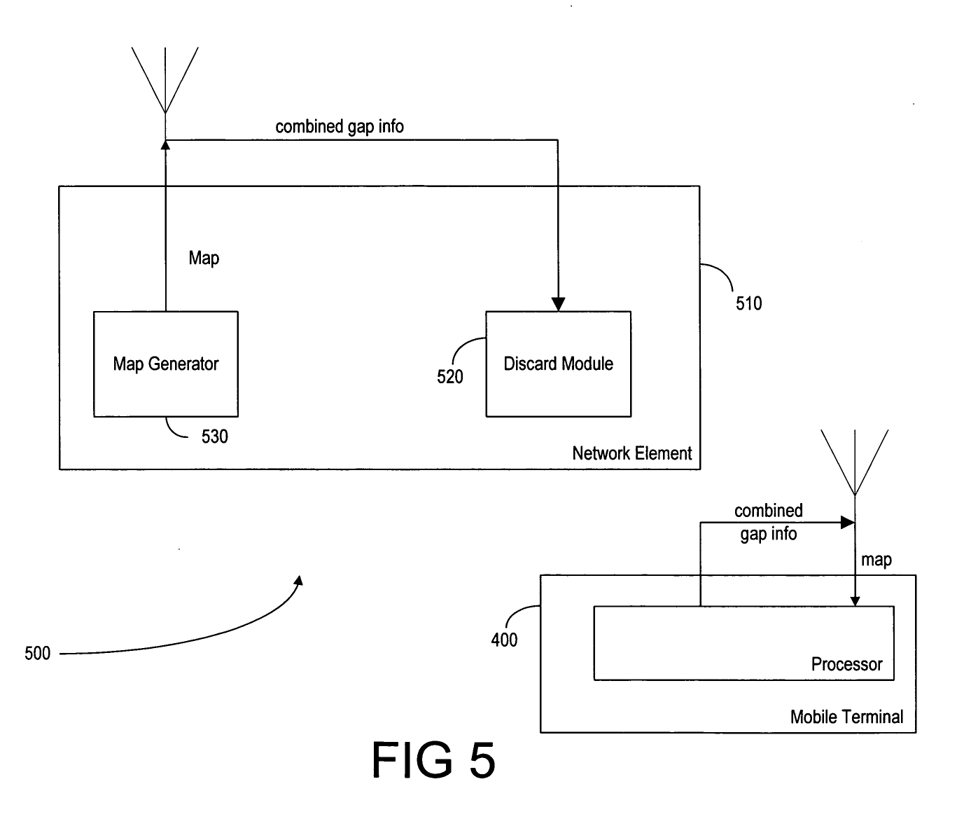

Referring now to FIG. 5, a system 500 is shown, including a network element 510, and the mobile terminal (i.e. mobile communication device) 400 already described above. The network element includes a map generator 530 which provides mapping information to the mobile terminal, describing traffic priority for various periods of time. If the mobile terminal ends up using the map to combine periods into a consecutive transmission gap, then information about that combined gap is returned from the mobile terminal to the network element, so that the network element's discard module 520 will cancel transmissions of packets for that combined period (as well as cancelling retransmissions of those packets).

The embodiments described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes the CPU processor 440 shown in FIG. 4, comprising a single processing unit, multiple processing units capable of parallel operation, or the CPU can be distributed across one or more processing units in one or more locations, e.g., on a client and server. Memory 420 may comprise any known type of data storage and/or transmission media, including magnetic media, optical media, random access memory (RAM), read-only memory (ROM), a data cache, a data object, etc. Moreover, similar to CPU 440, memory 420 may reside at a single physical location, comprising one or more types of data storage, or be distributed across a plurality of physical systems in various forms.

Without in any way limiting the scope of this invention, some of the concepts involved in this invention will now be briefly described.

The present application includes a first concept which is a method comprising: determining that an uplink or downlink transmission gap would be advantageous during at least one measurement; and combining at least one low priority period to form a consecutive gap that is at least as big as the determined gap.

The present application includes a second concept which is the first concept, further comprising initially notifying a user equipment of priorities of traffic that may occur during a plurality of respective periods, including the at least one low priority period.

The present application includes a third concept which is the second concept, wherein a network element provides the notification, and wherein the network element discards packets for the at least one low priority period without attempting to retransmit said packets.

The present application includes a fourth concept which is the first concept, wherein the combining is only performed if the determined transmission gap is greater than an allocated gap.

The present application includes a fifth concept which is the fourth concept, wherein the consecutive gap includes the allocated gap.

The present application includes a sixth concept which is the first concept, wherein the measurement is an inter-frequency measurement or a measurement pertaining to a different radio access technology, and wherein the measurement occurs in a handover situation.

The present application includes a seventh concept which is the third concept, wherein if the user equipment is in acknowledge mode instead of non-acknowledge mode, the discarding is in response to a skip notification from the user equipment, providing notification that said at least one low priority period is combined.

The present application includes an eighth concept which is an apparatus comprising: means for determining that an uplink or downlink transmission gap would be advantageous during at least one measurement; and means for combining at least one low priority period to form a consecutive gap that is at least as big as the determined gap.

The present application includes a ninth concept which is the eighth concept, wherein the apparatus utilizes an initial notification of priorities of traffic that may occur during a plurality of respective periods, including the at least one low priority period.

The present application includes a tenth concept which is the ninth concept, wherein the notification is from a network element, and wherein packets for the at least one low priority period are discarded without attempting to retransmit said packets.

The present application includes en eleventh concept which is the eighth concept, wherein the combining only occurs if the determined transmission gap is greater than an allocated gap.

The present application includes a twelfth concept which is the eleventh concept, wherein the consecutive gap includes the allocated gap.

The present application includes a thirteenth concept which is the eighth concept, wherein the measurement is an inter-frequency measurement or a measurement pertaining to a different radio access technology, and wherein the measurement occurs in a handover situation.

The present application includes a fourteenth concept which is the tenth concept wherein, if the user equipment is in acknowledge mode instead of non-acknowledge mode, the discarding is in response to a skip notification that the user equipment is configured to send in order to provide notification that said at least one low priority period is combined.

The present application includes a fifteenth concept which is an apparatus comprising: a determination module configured to determine that an uplink or downlink transmission gap would be advantageous during at least one measurement; and a combiner module configured to combine at least one low priority period to form a consecutive gap that is at least as big as the determined gap.

The present application includes a sixteenth concept which is the fifteenth concept, wherein the apparatus further comprises a memory configured to store an initial notification of priorities that may occur during a plurality of respective periods, and wherein the combiner module is configured to use the initial notification to identify the at least one low priority period.

The present application includes a seventeenth concept which is the sixteenth concept, wherein the notification is from a network element, and wherein packets for the at least one low priority period are discarded without attempting to retransmit said packets.

The present application includes an eighteenth concept which is the fifteenth concept, wherein the combining only occurs if the determined transmission gap is greater than an allocated gap.

The present application includes a nineteenth concept which is the eighteenth concept, wherein the consecutive gap includes the allocated gap.

The present application includes a twentieth concept which is the fifteenth concept, wherein the measurement is an inter-frequency measurement or a measurement pertaining to a different radio access technology, and wherein the measurement occurs in a handover situation.

The present application includes a twenty-first concept which is the fifteenth concept, wherein the apparatus is part of a mobile communication device.

The present application includes a twenty-second concept which is the seventeenth concept wherein, if the user equipment is in acknowledge mode instead of non-acknowledge mode, the discarding is in response to a skip notification that the user equipment is configured to send to the network element, notifying the network element that said at least one low priority period is combined.

The present application includes a twenty-third concept which is a software product for use in a wireless telecommunications environment, the software product comprising a computer readable medium having executable codes embedded therein; the codes, when executed, adapted to perform the functions of: determining that an uplink or downlink transmission gap would be advantageous during at least one measurement; and combining at least one low priority period to form a consecutive gap that is at least as big as the determined gap.

The present application includes a twenty-fourth concept which is the twenty-third concept, wherein a user equipment is initially notified of priorities of traffic that may occur during a plurality of respective periods, including the at least one low priority period.

The present application includes a twenty-fifth concept which is the twenty-fourth, wherein a network element provides the notification, and wherein the network element discards packets for the at least one low priority period without attempting to retransmit said packets.

The present application includes a twenty-sixth concept which is the twenty-third concept, wherein the combining is only performed if the determined transmission gap is greater than an allocated gap.

The present application includes a twenty-seventh concept which is the twenty-third concept, wherein the consecutive gap includes the allocated gap.

The present application includes a twenty-eighth concept which is the twenty-third concept, wherein the measurement is an inter-frequency measurement or a measurement pertaining to a different radio access technology, and wherein the measurement occurs in a handover situation.

The present application includes a twenty-ninth concept which is the twenty-fifth concept wherein, if the user equipment is in acknowledge mode instead of non-acknowledge mode, the discarding is in response to a skip notification from the user equipment, providing notification that said at least one low priority period is selected.

The present application includes a thirtieth concept which is a network element comprising: map generator configured to provide a map of traffic priorities that may occur during a plurality of respective periods; and discard module configured to discard packets for at least one low priority period indicated by the map, if said network element is informed that said at least one low priority period is selected as part of a consecutive gap that is larger than an allocated transmission gap.

The present application includes a thirty-first concept which is the thirtieth concept, wherein the network element is configured to neither transmit nor retransmit said discarded packets.

The present application includes a thirty-second concept which is a system comprising: a mobile communication device configured to determine a target uplink or downlink transmission gap that would be advantageous during at least one measurement, and further configured to combine at least one low priority period to form a consecutive gap that is at least as big as the target gap if the target transmission gap is greater than an allocated gap, wherein the combining uses an initial notification of priorities that may occur during a plurality of respective periods; and a network element configured to allocate the allocated gap, and configured to provide the initial notification in a map of traffic priorities.

The present application includes a thirty-third concept which is the thirty-second concept, wherein the network element is further configured to discard packets for the at least one low priority period, without attempting to transmit or retransmit said packets.

The present application includes a thirty-fourth concept which is the thirty-second concept wherein, if the user equipment is in acknowledge mode instead of non-acknowledge mode, the discarding is in response to a skip notification from the user equipment, providing notification that said at least one low priority period is combined.

It is to be understood that all of the present figures, and the accompanying narrative discussions of corresponding embodiments, do not purport to be completely rigorous treatments of the method, apparatus, system, network element, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method comprising:
determining that an uplink or downlink transmission gap would be advantageous during at least one measurement; and
combining at least one low priority period to form a consecutive gap that is at least as big as the determined gap.

2. The method of claim 1, further comprising initially notifying a user equipment of priorities of traffic that may occur during a plurality of respective periods, including the at least one low priority period.

3. The method of claim 2, wherein a network element provides the notification, and wherein the network element discards packets for the at least one low priority period without attempting to retransmit said packets.

4. The method of claim 1, wherein the combining is only performed if the determined transmission gap is greater than an allocated gap.

5. The method of claim 4, wherein the consecutive gap includes the allocated gap.

6. The method of claim 1, wherein the measurement is an inter-frequency measurement or a measurement pertaining to a different radio access technology, and wherein the measurement occurs in a handover situation.

7. The method of claim 3, wherein if the user equipment is in acknowledge mode instead of non-acknowledge mode, the discarding is in response to a skip notification from the user equipment, providing notification that said at least one low priority period is combined.

8. An apparatus comprising:
means for determining that an uplink or downlink transmission gap would be advantageous during at least one measurement; and
means for combining at least one low priority period to form a consecutive gap that is at least as big as the determined gap.

9. The apparatus of claim 8, wherein the apparatus utilizes an initial notification of priorities of traffic that may occur during a plurality of respective periods, including the at least one low priority period.

10. The apparatus of claim 9, wherein the notification is from a network element, and wherein packets for the at least one low priority period are discarded without attempting to retransmit said packets.

11. The apparatus of claim 8, wherein the combining only occurs if the determined transmission gap is greater than an allocated gap.

12. The apparatus of claim 11, wherein the consecutive gap includes the allocated gap.

13. The apparatus of claim 8, wherein the measurement is an inter-frequency measurement or a measurement pertaining to a different radio access technology, and wherein the measurement occurs in a handover situation.

14. The apparatus of claim 10, wherein, if the user equipment is in acknowledge mode instead of non-acknowledge mode, the discarding is in response to a skip notification that the user equipment is configured to send in order to provide notification that said at least one low priority period is combined.

15. An apparatus comprising:
a determination module configured to determine that an uplink or downlink transmission gap would be advantageous during at least one measurement; and
a combiner module configured to combine at least one low priority period to form a consecutive gap that is at least as big as the determined gap.

16. The apparatus of claim 15, wherein the apparatus further comprises a memory configured to store an initial notification of priorities that may occur during a plurality of respective periods, and wherein the combiner module is configured to use the initial notification to identify the at least one low priority period.

17. The apparatus of claim 16, wherein the notification is from a network element, and wherein packets for the at least one low priority period are discarded without attempting to retransmit said packets.

18. The apparatus of claim 15, wherein the combining only occurs if the determined transmission gap is greater than an allocated gap.

19. The apparatus of claim 18, wherein the consecutive gap includes the allocated gap.

20. The apparatus of claim 15, wherein the measurement is an inter-frequency measurement or a measurement pertaining to a different radio access technology, and wherein the measurement occurs in a handover situation.

21. The apparatus of claim 15, wherein the apparatus is part of a mobile communication device.

22. The apparatus of claim 17, wherein, if the user equipment is in acknowledge mode instead of non-acknowledge mode, the discarding is in response to a skip notification that the user equipment is configured to send to the network element, notifying the network element that said at least one low priority period is combined.

23. A software product for use in a wireless telecommunications environment, the software product comprising a computer readable medium having executable codes embedded therein; the codes, when executed, adapted to perform the functions of:
determining that an uplink or downlink transmission gap would be advantageous during at least one measurement; and
combining at least one low priority period to form a consecutive gap that is at least as big as the determined gap.

24. The software product of claim 23, wherein a user equipment is initially notified of priorities of traffic that may occur during a plurality of respective periods, including the at least one low priority period.

25. The software product of claim 24, wherein a network element provides the notification, and wherein the network element discards packets for the at least one low priority period without attempting to retransmit said packets.

26. The software product of claim 23, wherein the combining is only performed if the determined transmission gap is greater than an allocated gap.

27. The software product of claim 23, wherein the consecutive gap includes the allocated gap.

28. The software product of claim 23, wherein the measurement is an inter-frequency measurement or a measurement pertaining to a different radio access technology, and wherein the measurement occurs in a handover situation.

29. The software product of claim 25, if the user equipment is in acknowledge mode instead of non-acknowledge mode, the discarding is in response to a skip notification from the user equipment, providing notification that said at least one low priority period is selected.

30. A network element comprising:
a map generator configured to provide a map of traffic priorities that may occur during a plurality of respective periods; and
a discard module configured to discard packets for at least one low priority period indicated by the map, if said network element is informed that said at least one low priority period is selected as part of a consecutive gap that is larger than an allocated transmission gap.

31. The network element of claim 30, wherein the network element is configured to neither transmit nor retransmit said discarded packets.

32. A system comprising:
a mobile communication device configured to determine a target uplink or downlink transmission gap that would be advantageous during at least one measurement, and further configured to combine at least one low priority period to form a consecutive gap that is at least as big as the target gap if the target transmission gap is greater than an allocated gap, wherein the combining uses an initial notification of priorities that may occur during a plurality of respective periods; and
a network element configured to allocate the allocated gap, and configured to provide the initial notification in a map of traffic priorities.

33. The system of claim 32, wherein the network element is further configured to discard packets for the at least one low priority period, without attempting to transmit or retransmit said packets.

34. The system of claim 32, wherein, if the user equipment is in acknowledge mode instead of non-acknowledge mode, the discarding is in response to a skip notification from the user equipment, providing notification that said at least one low priority period is combined.
